(19) United States
(12) Patent Application Publication
(10) Pub. No.: US 2014/0251806 A1
(43) Pub. Date: Sep. 11, 2014

(54) WATER TREATMENT ARRANGEMENT FOR STEAM-ASSISTED OIL PRODUCTION OPERATION

(71) Applicant: Siemens Energy, Inc., Orlando, FL (US)

(72) Inventors: Andrea J. Larson, Wausau, WI (US); Chad L. Felch, Kronenwetter, WI (US)

(73) Assignee: Siemens Energy, Inc., Orlando, FL (US)

(21) Appl. No.: 14/195,920

(22) Filed: Mar. 4, 2014

Related U.S. Application Data
(60) Provisional application No. 61/773,861, filed on Mar. 7, 2013.

(51) Int. Cl. C02F 1/469

(52) U.S. Cl. CPC C02F 1/4695; C02F 2201/48; C02F 2103/365
USPC 204/450; 204/600; 204/627

(57) ABSTRACT

A water processing arrangement (18) for steam assisted oil production, having a water softening system (30) configured to remove silica from a stream of producer well water (64, 66) using a caustic (70), and an electrodeionization-based water deionization system (36) downstream of the water softening system configured to deionize the stream of water (66) A byproduct of the electrodeionization is caustic NaOH which is recycled to the softening system

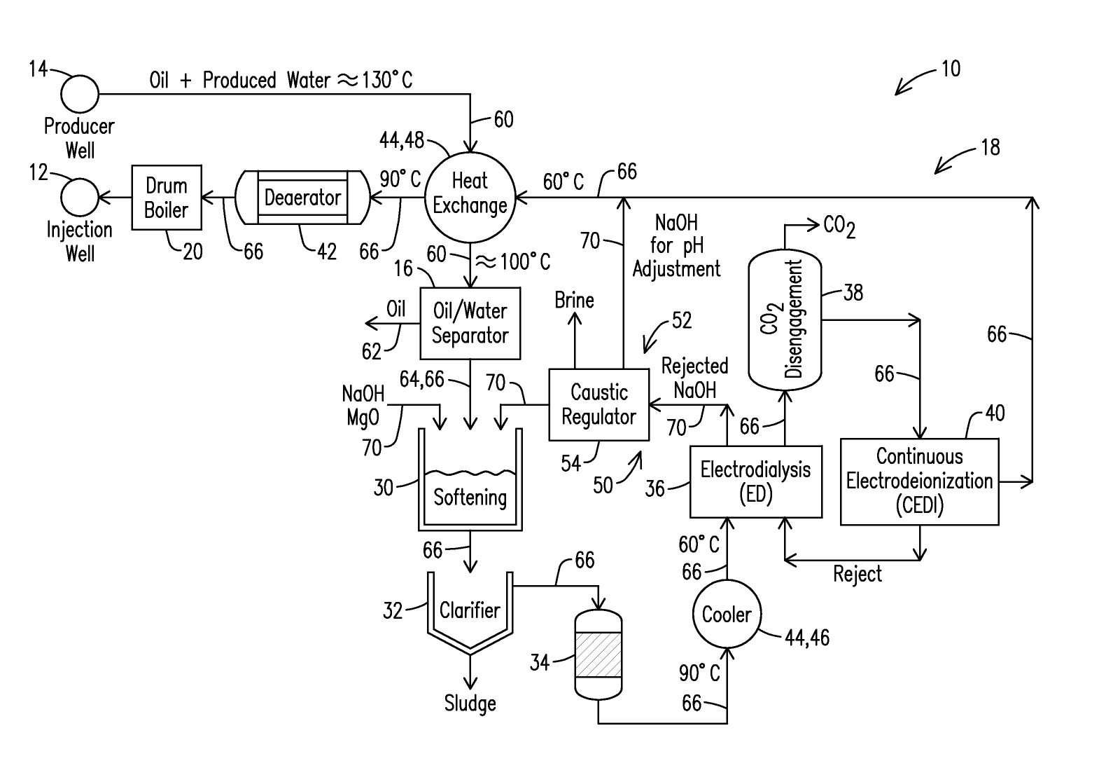

This application claims benefit of the Mar. 7, 2013 filing date of U.S. provisional patent application No. 61/773,861 which is incorporated by reference herein

### FIELD OF THE INVENTION

The invention relates to an arrangement for treating produced water from a producer well of a steam-assisted oil production operation.

### BACKGROUND OF THE INVENTION

A steam-assisted oil production operation, such as a steam assisted gravity drainage (SAGD) operation, requires high volumes of water for hydraulic fracturing to extract bitumen or high viscosity oil from heavy oil reservoirs, or as an enhanced oil recovery technique from more traditional wells Feed water is fed to a boiler where steam is created This steam is injected into an injection well The steam increases oil production and oil into a producer well A mixture of produced water and oil is brought to the surface where the oil is separated, leaving water that typically needs to be treated for either discharge or reuse.

The historical approach to treating the produced water from steam assisted oil production includes lime softening, including silica removal to prevent scaling, followed by clarification to remove precipitates, followed by weak acid cation (WAC) exchange Water from this type of treatment is then fed to a once through steam generator (OTSG) that has been modified so that it can produce steam of 100% quality required for SAGD operation Unmodified OTSGs typically produce about 80% steam quality Unmodified OTSGs require long lead times and are expensive The modifications, which include adding several knock out pots to remove condensate, add to the time and cost of acquisition In addition, the lime softening and WAC exchange of the historical approach require chemicals There is cost associated with the acquisition, handling, and disposal of the chemicals, such as lime slurry handling and sludge disposal

An alternate known approach for treating the produced water replaces the more expensive, modified OTSG with a less expensive drum boiler (i e package boiler) In this alternate process, produced water is pH adjusted to keep silica soluble and is fed into a mechanical vapor compressor (MVC) that essentially distills the water This process creates water of such quality that when boiled in a package boiler, steam of 100% quality is produced In this process, up to 97% water recovery is possible since only a small amount of blow down is required In addition, zero liquid discharge (ZLD) is possible Optionally, water being fed to the MVC may be preheated by taking heat from water exiting the MVC Since produced water is typically hot (approximately 130 degrees Celsius from the ground), it may be possible to add little or no heat with the MVC Instead, the vapor compressive cycle elevates the existing steam temperature to produce the distillate However, these systems are very expensive to acquire and to operate

### BRIEF DESCRIPTION OF THE DRAWINGS

The invention is explained in the following description in view of the sole drawing that schematically depicts a steam-assisted gravity drainage (SAGD) operation having a water processing arrangement as disclosed herein

### DETAILED DESCRIPTION OF THE INVENTION

The present inventors have devised a new and innovative arrangement for processing water from a producer well of a steam-assisted oil production so that it can be used to produce steam for use in an injector well The arrangement includes relatively inexpensive water treatment technologies which can be paired with a relatively inexpensive drum boiler to produce steam of 100% quality

A typical steam assisted produced water (producer well water) may have about 10 ppm hardness (as CaCO₃—calcium carbonate), 150-300 ppm silica (such as SiO₂), 2000 ppm (0 2%) total dissolved solids (TDS) (primarily NaCl—sodium chloride and NaHCO₃—sodium bicarbonate) Electrodeionization systems such as electrodialysis (ED) systems typically are not useful for treatment of water having high total dissolved solids (TDS) because removal of substantial amounts of TDS requires substantial amounts of power, thereby making ED treatment commercially unfeasible Furthermore, because membranes typically used in electrodeionization systems are temperature sensitive, it is counter-intuitive to employ a water treatment method that requires relatively cool water in a process wherein heat in the water is an economic asset Unexpectedly, the present inventors have developed a water treatment arrangement for steam assisted operations that, in one embodiment, includes softening using caustic and electrodeionization The inventors have found that this combination of treatment operations provides unique advantages that overcome the bias against the use of ED treatment for such applications

The sole FIGURE schematically shows an exemplary embodiment of a steam assisted gravity drainage (SAGD) operation 10, which is one form of steam assisted oil production It includes a SAGD injection well 12, a SAGD producer well 14, an oil/water separator 16, and a water processing arrangement 18 Examples of oil/water separation include primary separation such as a corrugated plate interceptor, secondary separation such as dissolved or induced gas flotation, and tertiary separation such as a walnut shell filter

As shown, the water processing arrangement 18 includes a boiler 20 that may be any type of suitable boiler, including a drum boiler, also known as a package boiler, or a modified Once Through Steam Generator (OTSG). In an alternate exemplary embodiment, the water processing arrangement 18 may be considered to exclude the boiler 20 and be limited to elements that perform aspects of water treatment other than steam generation The exemplary water processing arrangement 18 also includes a water softening system 30, a clarifier 32, an optional filter 34 such as an activated carbon, walnut shell, or sand filter, an electrodeionization-based water deionization system 36, a carbon dioxide disengagement unit 38, a polishing system 40, and a deaerator 42.

The electrodeionization-based water deionization system 36 may be an electrodialysis (ED) system, a continuous electrodeionization (CEDI) system, an electrodialysis reversal system, and/or a capacitive deionization system In the exemplary embodiment the electrodeionization-based water deionization system 36 is an ED system 36 The ED system 36 may use a single module or banks of modules

The polishing system 40 may be a continuous electrodeionization (CEDI) system, an ion exchange column, a reverse osmosis system, or any suitable water polishing system known in the art In the exemplary embodiment disclosed herein, the polishing system 40 is a CEDI system 40 As is known in the art, CEDI is a deionization system similar to electrodialysis, but goes one step further by placing resin beads between the ion exchange membranes The resin beads provide a flow path for the electricity through the water to overcome the increasing electrical resistance of the water that results as the water purity increases Similar to an electrodialysis unit, a CEDI system may use one module or banks of modules

An optional thermal arrangement 44 may include a cooler 46 and/or a boiler preheat heat exchanger 48. The cooler 46 may be necessary to cool the stream of water 66 entering the ED system 36 to a temperature that will not harm the internal ion exchange membrane (not shown) There may also be a recycle loop 50 configured to transfer caustic from the ED system 36 to the water softening system 30, and/or to an optional post-polishing pH adjustment loop 52 configured to transfer caustic from the ED system 36 to water that has exited the CEDI system 40 A caustic regulator 54 may regulate the flows of caustic in the recycle loop 50 and the post-polishing pH adjustment loop 52 Alternately, plural caustic regulators 54 may be used, one for each loop

In operation a mixture 60 of oil 62 and SAGD-produced water 64 (producer well water) emanates from the producer well 14 at approximately 130 degrees Celsius and enters the boiler preheat heat exchanger 48, where heat is optionally transferred to a stream of water 66 that has been deionized and is enroute to the boiler 20 This cools the mixture 60 to, for example, about 100 degrees Celsius while heating the stream of water 66 from, for example, about 60 degrees Celsius to about 90 degrees Celsius The mixture 60 flows into the oil/water separator 16 where the oil 62 is separated from the SAGD produced water 64, which, from this point and downstream is also referred to herein as the stream of water 66

The hardness, silica, and dissolved solids in the SAGD-produced water must be addressed before the SAGD-produced water can be reused to create steam suitable for the injection well 12 Silica in particular must be removed to address scaling A typical SAGD operation 10 may require about 3000 gallons per minute of water to sustain operation, and so any process must be able to accommodate such a flow rate

The stream of water 66 enters the water softening system 30 where it is softened. A caustic 70 and source of magnesium may be used to remove the silica which is prevalent in SAGD-produced water 64 The caustic 70 may include sodium hydroxide (NaOH) or other forms of alkalinity to increase the solution pH The magnesium source may include magnesium oxide (MgO), magnesium chloride (MgCl₂), magnesium hydroxide (Mg(OH)₂), or magnesium sulfate (MgSO₄) By using a caustic 70 together with the magnesium source for softening, the caustic does not add any TDS to the stream of water 66, unlike prior art arrangements that use lime softening While magnesium oxide (MgO) typically requires an environment of at least 70 degrees Celsius (160 degrees Fahrenheit) to be effective, this is not an issue in this arrangement since the stream of water is hot enough Lime may also be used in conjunction with the caustic 70 if desired The stream of water 66 exits the water softening system 30 and is clarified in the clarifier 32 to prevent carryover of suspended solids Precipitated solids, including silicates (such as magnesium silicate) would be removed via sludge and disposed

The stream of water 66 may optionally flow through a filter 34 which may include, for example, a walnut shell, activated carbon, or sand filter where suspended solids and/or organics are removed, for example trace amounts of oil that may be problematic for downstream membranes The stream of water 66 may then flow through the cooler 46, if necessary, to protect the downstream components from excessive heat For example, ion exchange membranes used in electrodialysis may be damaged if exposed to excessive heat A common maximum safe temperature using current membrane technology may be 60 degrees Celsius Heat removed at this stage may be reused within the SAGD operation 10 as desired for optimal economy

In the ED system 36, the stream of water 66 is subjected to an electrodialysis process where hardness and TDS are removed (i e where ions present in the stream of water 66 are removed) One benefit of this scheme is that up to a large proportion (10%-90%) of the TDS in the SAGD-produced water 64 is present as NaHCO₃ (sodium bicarbonate), and this is readily removed by electrodialysis Thus, a byproduct of the electrodialysis of SAGD-produced water 64 is sodium hydroxide (NaOH), which is a caustic

An electrodialysis module uses electricity to move ions (based on charge) via an electric current flowing between an anode and a cathode Cells are configured with selective membranes in each module to allow or block movement of ions to adjacent cells, allowing some cells, such as a cell having the water being deionized, to be depleted of ions Other cells, such as reject stream cells, are concentrated with the ions that were removed As the stream of water 66 flows through the cells, the cations such as sodium will be attracted to the cathode, and anions such as hydroxide, chloride, and sulfate will be attracted to the anode Consequently, ions are depleted from some cells and concentrated into others When bicarbonate is present, the hydroxide ion is removed, leaving carbon dioxide in that cell, reducing the pH. The hydroxide ion then combines with a cation, such as sodium, in the adjacent cell, forming caustic. Thus, as CO₂ gas is released the NaOH is created

The caustic 70 produced in the ED system 36 may be recycled via the recycle loop 50 to the water softening system 30 to serve as the caustic 70 used to remove the silica Thus, this arrangement separates ions from the stream of water 66, and then reuses a caustic 70 formed from the separated ions. This is a fundamentally different concept than evaporative technologies that can be characterized as removing the water from the ions (present in a remaining brine pool) during evaporation The caustic regulator 54 will regulate the amount of caustic 70 recycled and the amount that is rejected in brine It is believed that a bulk of the caustic 70 needed in the water softening system 30 can be generated by the ED system 36 Using recycled caustic 70 in this manner obviates the need for lime softening and associated installation and operating costs and complexities, and reduces the amount of sludge that must be processed In addition, lime softening conventionally uses lime that must be dosed from a solid form, which is difficult to do accurately Thus, while lime softening may be less expensive than caustic softening in other prior art arrangements, in the present arrangement where the caustic 70 is self-generated, it is less expensive to use caustic 70 Further, adding lime for softening adds calcium to the water, which must later be removed, whereas the caustic added in the arrangement disclosed herein is recycled from the stream of water 66 It is recognized that it may be beneficial in some applications to use some lime in conjunction with caustic 70, however, the advantage of recycling caustic remains. Since the recycled caustic 70 may have relatively low strength and may contain salts, it may not be suitable for sale However, recycled caustic 70 may be used elsewhere within the operation. For example, it may be used to adjust pH in other flow streams, and/or it may be used in a clean in place (CIP) process to clean components of the operation 10, or any other secondary use suitable for the caustic

As detailed above, carbon dioxide (CO₂) may be released during the electrodialysis process as the ions are removed and pH is reduced This gas production may increase a resistivity of the stream of water 66 in the ED system 36 and this, in turn, may require more power to drive the electrodialysis process However, this cost may be acceptable given the gains provided elsewhere by the arrangement The released carbon dioxide may be disengaged from the flow of water 66 in the carbon dioxide disengagement unit 38 Consequently the TDS associated with the bicarbonate is removed from the system. This results in a reduced amount of salt in the brine that needs to be disposed. The disengaged CO₂ may be recovered, which may add further value to the water processing arrangement 18

The stream of water 66 may then optionally flow into a polishing system such as the CEDI system 40 where it is further deionized to a level beyond that attained by the ED system 36.

In order for the equilibrium to shift to achieve complete TDS removal of NaHCO₃, the pH needs to be below 4 5 When the pH is this low, the desired buffering effects of the salts are gone If required to satisfy the drum boiler feed water specification requirements, the pH may be increased downstream of the CEDI system 40 To accomplish this, some of the sodium hydroxide caustic 70 generated in the ED system 36 may be directed to the stream of water 66 after it exits the CEDI system 40 via the post-polishing pH adjustment loop 52 The caustic regulator 54 may also regulate this amount of caustic so that only enough caustic is added back to achieve the desired pH without overshooting it Alternately, plural NaOH regulators may be used, one for each loop

The stream of water 66 flowing from the CEDI system 40 may flow through the boiler preheat heat exchanger 48 where the heat drawn from the mixture 60 of oil 62 and SAGD-produced water 64 may be transferred to the stream of water 66 This would raise the temperature from, for example, 60 degrees Celsius to about 90 degrees Celsius This preheat will reduce fuel costs for the boiler 20 This fuel cost reduction, together with the proposed arrangement, may reduce a total cost of this arrangement to below that of the prior art arrangements The thermal arrangement 44 may be considered to include both the cooler 46 and the boiler preheat heat exchanger 48 as separate components Alternately, since heat is being removed from the stream of water 66 at the cooler 46 and returned to the same stream of water 66 at the boiler preheat heat exchanger 48, the thermal arrangement 44 may employ a single heat exchanger, or a regenerative heat transfer unit In such an arrangement, the heat energy may be more efficiently transferred as desired

The stream of water 66 may then be deaerated in the deaerator 42, at which point it is suitable to be feedwater for the boiler 20 Once heated in the boiler 20, steam of proper quality is created and delivered to the injection well 12

As noted above, the boiler 20 may be a package boiler, or a modified OTSG Package boilers have extremely high water purity requirements In particular, the water must be nearly free of ions Consequently, when the water processing arrangement 18 is used with a package boiler, the polishing system 40 may be necessary Modified OTSG's, on the other hand, have high hardness requirements, but perhaps lower overall TDS requirements Consequently, if the water processing arrangement 18 is used with a modified OTSG, the polishing system 40 may not be necessary

The capital cost of the water processing arrangement 18 disclosed herein is expected to be significantly below that of the traditional lime softening, ion exchange beds, and OTSG or an evaporator arrangement Evaporators are very expensive due in part to the materials of construction, and as a result may be a last resort Further, evaporators are not immune to fouling concerns, including hydrocarbon fouling Subject to variables such as power/fuel cost and an ability to extract heat from the SAGD-produced water, analysis reveals that when capital expenses and operating expenses are reviewed in total, the water processing arrangement 18 may provide a lower overall cost than an evaporator or once through steam generator system As a result, the proposed system represents an improvement in the art

While various embodiments of the present invention have been shown and described herein, it will be obvious that such embodiments are provided by way of example only Numerous variations, changes and substitutions may be made without departing from the invention herein Accordingly, it is intended that the invention be limited only by the spirit and scope of the appended claims

The invention claimed is:

1. A water processing arrangement, comprising
a water softening system configured to remove silica from a stream of producer well water using caustic, and
an electrodeionization-based water deionization system downstream of the water softening system configured to deionize the stream of water

2. The water processing arrangement of claim 1, further comprising a recycle loop configured to return caustic produced in the water deionization system to the water softening system

3. The water processing arrangement of claim 2, wherein the water deionization system further comprises an electrodialysis (ED) system.

4. The water processing arrangement of claim 1, further comprising a polishing system downstream of the water deionization system

5. The water processing arrangement of claim 1, comprising a thermal arrangement configured to cool the stream of water prior to the water deionization system and to heat the stream of water after the water deionization system

6. The water processing arrangement of claim 1, further comprising a drum boiler configured to boil the stream of water into steam suitable for use in an injection well

7. A water processing arrangement, comprising
a water softening system receiving a stream of producer well water, and
an electrodeionization system to deionize the stream of water

8. The water processing arrangement of claim 7, further comprising a recycle loop configured to return a caustic produced in the water deionization system and comprising chemical elements removed from the stream of water to the water softening system to remove silica from the stream of water

9. The water processing arrangement of claim 7, wherein the electrodeionization system comprises an electrodialysis system, and wherein the water processing arrangement further comprises a polishing system

10. The water processing arrangement of claim 9, further comprising a post-CEDI pH adjustment loop configured to transfer caustic produced in the electrodeionization system to the stream of water downstream of the CEDI system to raise a pH of the stream of water

11. The water processing arrangement of claim 7, comprising a thermal arrangement configured to cool the stream of water prior to the electrodeionization system and to heat the stream of water after the electrodeionization system

12. The water processing arrangement of claim 11, the thermal arrangement further comprising a boiler preheat heat exchanger configured to transfer heat from the stream of water to the stream of water downstream of the electrodeionization system

13. The water processing arrangement of claim 7, further comprising a boiler configured to boil the stream of water downstream of the water deionization system for use in a steam assisted oil production injection well

14. The water processing arrangement of claim 7, further comprising a clarifier configured to filter precipitated silicates downstream of the water softening system, a carbon dioxide disengagement unit downstream of the electrodeionization system and configured to disengage carbon dioxide generated in the electrodeionization system; and a deaerator downstream of the carbon dioxide disengagement unit and configured to deaerate the stream of water

15. The water processing arrangement of claim 14, further comprising a filter downstream of the clarifier configured to remove organics from the stream of water

16. A steam assisted oil production operation comprising the water processing arrangement of claim 7, and further comprising,
a producer well configured to generate a mixture of oil and producer well water,
an oil/water separator configured to separate oil from the mixture, thereby creating the stream of producer well water, and
an injection well configured to receive the stream of water downstream of the electrodeionization-based water deionization system

17. A method of processing water, comprising
receiving a stream of producer well water,
softening the stream of water to remove silica using a caustic,
deionizing the softened stream of water via an electrodeionization process;
generating caustic for the softening step in the electrodeionization process, and
changing the deionized stream of water into steam for an injection well

18. The method of claim 17, further comprising:
cooling the stream of water before the electrodeionization process, and
preheating the stream of water after the electrodeionization process using heat present in the stream of producer well water enroute to be softened

19. The method of claim 17, further comprising polishing the stream of water after the electrodeionization process, and using caustic generated during the electrodeionization process to raise a pH of the stream of water after the polishing process

20. The method of claim 17, further comprising using caustic generated during the electrodeionization process for a secondary use.
